(19) United States
(12) Patent Application Publication
(10) Pub. No.: US 2015/0134298 A1
(43) Pub. Date: May 14, 2015

(54) SYSTEM AND METHOD FOR GENERATING FOREST FIRE AIRTANKER OPERATIONS DATA

(71) Applicant: The Governing Council of the University of Toronto, Toronto (CA)

(72) Inventors: Nicholas Andrew Clark, Brampton (CA); David Leigh Martell, Toronto (CA)

(21) Appl. No.: 14/076,759

(22) Filed: Nov. 11, 2013

(51) Int. Cl. A62C 3/02; G01B 21/16

(52) U.S. Cl. CPC A62C 3/0228; G01B 21/16
USPC 702/189

(57) ABSTRACT

A system and method for generating forest fire operations data and storing the operations data for use in modeling. An exemplary system comprises one or more location tracking module linked to each of a plurality of airtankers, each location tracking module operable to generate location data corresponding to tracking the location of the airtanker in real time or near real time, and a processing module operable to generate the operations data from the collected location data.

### TECHNICAL FIELD

The following relates generally to modeling forest fire airtanker operations and more specifically for determining airtanker trip information from data obtained in respect of forest fire air attack.

### BACKGROUND

In 2011, 1,334 forest fires burned approximately 635,374 hectares in the province of Ontario. Although the Ontario Ministry of Natural Resources (OMNR) spent approximately $230 million on their forest fire operations program in 2011 ($110 million more than the yearly average) to help curb the damage caused by forest fires, the 2011 fire season had the most area burned in the last 50 years. In addition, health concerns from smoke and direct fire threat forced 4,476 people from their homes across several northern Ontario communities.

An important component of forest fire management in Ontario is the initial attack processes which are intended to quickly dispatch firefighters and/or airtankers so that they can begin suppression action on newly reported fires as soon as possible. Generally, a three to five person ground crew is supervised by a crew leader who is usually designated the initial attack fire boss or incident commander (IC). The IC's primary objective is to contain initial attack fires as quickly as possible. Most fires are detected and reported while or when they are small enough to be controlled by initial attack forces. However, fires occasionally escape initial attack, and are subsequently declared as extended attack fires that may require suppression efforts over an extended period of days or weeks in order to achieve containment.

The goal of an air attack officer (in coordination with the ground-based IC) is to reduce the intensity of the fire by instructing pilots that are operating airtankers to drop water on the active flame front and/or build a wetted area on and around the fire with successive water drops. This suppression method usually delays the growth of the fire until ground suppression crews reach the fire and begin direct suppression efforts and in some cases, it virtually extinguishes the fire. Airtankers are extremely effective firefighting resources because they have the ability to drop thousands of litres of water or retardant onto or around the fire. Since airtankers are both costly and effective fire suppression resources, fire managers devote significant effort to determining how best to utilize their fleet of airtankers.

Each day forest fire managers must decide how many airtankers to deploy, where to deploy them at the start of the day and how to re-deploy them throughout the day to minimize their response time to fires, which is the time between when a fire is first reported and when an airtanker first arrives on scene of the fire. Since fires can grow in size and intensity while they wait to receive suppression action, minimizing the response time is critical. Fire managers must consider the risk of having insufficient airtankers available for dispatch to fires during periods of high fire activity.

This is a very complex decision-making problem. The final decision is based on a subjective assessment of the situation that is often based on years of experience. The number of airtankers dispatched to a fire is subjectively determined by experienced fire managers who consider the characteristics of the fire, current and forecasted weather conditions, the proximity of the fire to nearby communities and commercial and non-commercial values at risk, the expected fire occurrence for the remainder of the day, the number and location of available airtankers and other suppression resources at the time a fire is reported. If all airtankers are busy, however, the fire is typically allocated to an initial attack queue and served once an airtanker becomes available. The fire may also be removed from the queue if an initial attack crew has contained the fire before the next airtanker becomes available, or if the fire's behaviour has changed due to a sudden change in weather conditions and no longer poses a significant threat to the safety of communities and other values.

Meanwhile, the United States General Accountability Office (GAO) notes that American governments lack data-driven analyses of airtanker performance and effectiveness. Consequently, airtanker purchasing, dispatching and many other management decisions are not presently made on the basis of adequate data-driven analyses.

### SUMMARY

In one aspect, a system for generating forest fire airtanker operations data is provided, the system comprising: (a) a location database configured to store location data corresponding to each of a plurality of airtankers used for forest fire air attack; (b) a forest fire database for storing forest fire data; and (c) a processing module operable to generate, using said location data and forest fire data, said operations data comprising a plurality of trip segments for each airtanker for each forest fire air attack and events and measures corresponding to said trip segments.

In another aspect, a method for generating forest fire attack operations data is provided, the method comprising: (a) obtaining location corresponding to each of a plurality of airtankers used for forest fire air attack; (b) obtaining forest fire data; and (c) generating, by a processor, using said location data and forest fire data, said operations data comprising a plurality of trip segments for each airtanker for each forest fire air attack and events and measures corresponding to said trip segments.

### BRIEF DESCRIPTION OF THE DRAWINGS

The features of the invention will become more apparent in the following detailed description in which reference is made to the appended drawings wherein:

FIG. 1 is a flowchart of trip events for an airtanker trip;

FIG. 2 is a flowchart of an example of a typical air attack service cycle;

FIG. 3 is an architecture diagram of a system for generating forest fire airtanker operations data;

FIG. 4 is a flowchart describing how the processing module generates forest fire airtanker operations data; and

FIG. 5 illustrates airtanker speed and altitude corresponding to water pickup events;

### DETAILED DESCRIPTION

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will also be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media.

The following relates generally to generating forest fire airtanker operations data (hereinafter “operations data”) and more specifically for generating airtanker trip data from data obtained in respect of the air attack service cycle, including airtanker location data (hereinafter “location data”). The generated data may be encapsulated by an airtanker service process (ASP) database.

An exemplary system comprises one or more location tracking modules linked to each of a plurality of airtankers, each location tracking module operable to generate location data corresponding to tracking the location of the airtanker in real time or near real time, and a processing module operable to generate operations data from the collected location data and other data sources.

The system further comprises forest fire data. Forest fire data is compiled by dispatchers or operations administrator and relates to data in respect of the time, location and conditions relating to or surrounding each forest fire.

The location data and forest fire data are provided to the processing module. The processing module implements a pattern recognition process to generate the operations data, which includes determining which airtankers are serving which fires and the processes undertaken by each such airtanker in the course of fighting each such fire. The generated operations data may be stored in an airtanker service process (ASP) database. The ASP database provides a plurality of data items usable by fire managers, dispatchers and researchers.

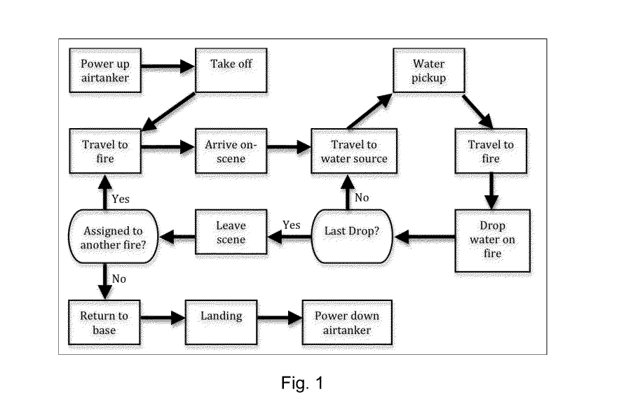

It has now been found that the airtanker service process can be generally modeled based upon a series of events characterizing an “airtanker trip”. FIG. 1 is an example of an airtanker trip during forest fire air attack. The trip comprises a series of distinct trip events that map to the segments of the air attack service cycle, including:
1. Pilot completes standard pre-flight check, powers up his or her airtanker and prepares for takeoff. In certain examples, for example where in-flight water pickup is not available, the airtanker has previously been loaded with a fire retardant.
2. Airtanker taxis to the end of the runway and waits for takeoff clearance from the tower.
3. Airtanker accelerates down the runway and takes off once the required speed is achieved.
4. Airtanker travels to the vicinity of the fire on a relatively straight line flight path. Pilot communicates with air attack officer while en route to the fire.
5. Airtanker arrives in close proximity to the fire.
6. Airtanker pilot scouts the fire and the region for usable lakes or rivers under the direction of the air attack officer, if the airtanker will be conducting one or more water pickups (i.e., has not been previously loaded with sufficient fire retardant to fight the fire).
7. Airtanker scoops up water by skimming the surface of a lake or river, if the airtanker will be conducting water pickup.
8. Airtanker flies back to the fire.
9. Load of water is dropped on the fire. Airtanker may have to wait while the drop area is cleared of fire crews, resources/equipment, helicopters and/or other response vehicles.
10. If last drop, then airtanker leaves scene of the fire, and proceeds to trip event 11. Otherwise, if the airtanker will be conducting water pickup, airtanker returns to the lake, and repeats events 7 through 9 until the required number of drops have been delivered.
11. Travel to next fire or return to a base. If assigned to another fire, airtanker proceeds from event 4. Otherwise, airtanker returns to a base.
12. Airtanker lands on the runway and comes to a halt.
13. Airtanker taxis to ramp.
14. Pilot powers down the airtanker. If the airtanker requires loading of fire retardant, it is loaded (though the airtanker need not be powered down to load retardant).

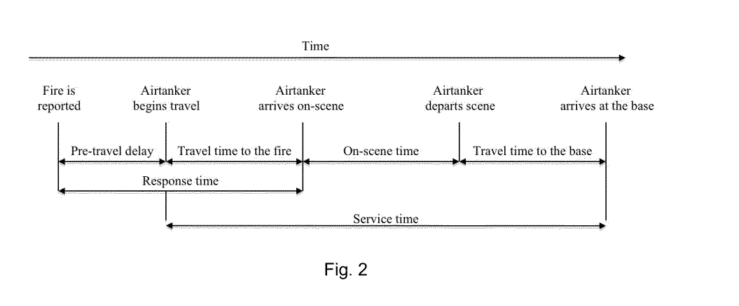

FIG. 2 shows an example of the air attack service cycle and how many of the airtanker trip events relate, in an example including in-flight water pickup. A first segment of the cycle is a pre-travel delay, which comprises the period beginning at the time the fire is reported and ending at the time the airtanker begins travel. The second segment of the cycle is the travel time to the fire, which is considered to begin when the airtanker is powered on and ends when the first pickup of water is made. The third segment of the cycle is the on-scene time, which begins when the first pickup of water is made by an airtanker and ends when the last load of water is dropped on the fire. The final segment of the cycle is the travel time either (i) from the fire back to the base, which begins after the last drop has been delivered and ends once the airtanker is powered down at an airport, or (ii) from the fire to another fire, provided the airtanker has sufficient fuel to engage in another fire attack.

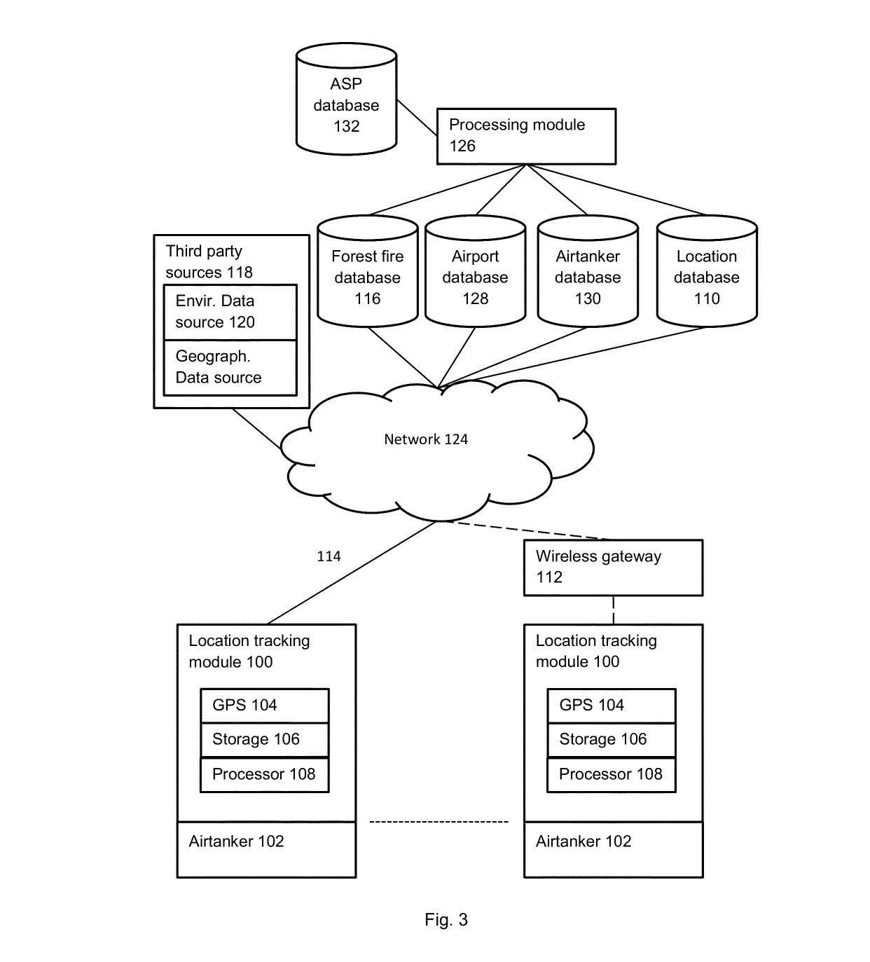

Referring now to FIG. 3, a system in accordance with the foregoing comprises a plurality of location tracking modules 100, each linked to an airtanker 102. It will, however, be appreciated that a single such module linked to a single such airtanker would suffice, for example where the air fleet comprises just one airtanker. Each location tracking module 100 is operable to collect location data of the corresponding airtanker 102 in real time or near real time.

In implementations, the location tracking module 100 may be configured to collect location data at prescribed intervals, such as every 30 seconds, or to collect location data based on achieving particular qualifying thresholds, for example every 20 minutes while the airtanker is stationary (i.e., the location data is unchanged) but more frequently, for example every 30 seconds, when movement of the airtanker has commenced (i.e., a location variation is found between adjacent location data points). An exemplary location tracking module comprises a GPS receiver 104 and local storage 106, and may further comprise a processing unit 108 for generating and enabling the storage of the location data or parts thereof.

Each location data point comprises at least date/time, latitude, longitude and altitude. From the foregoing, the processing unit 108 of the location tracking module can generate heading and speed for each data point. In an example, date/time is recorded in the format MM/DD/YYYY hh:mm:ss AM/PM in Greenwich Mean Time (GMT); latitude and longitude in degrees, minutes, seconds format (e.g., 48:11:56N/90:36:55W); altitude in feet above sea level at predetermined intervals (which may be dependent upon resolution of the location tracking module, e.g., 8 foot intervals); heading in degrees (i.e., 0-360 degrees), derivable from adjacent (or closely spaced) data points using latitude and longitude; and speed in knots, derivable from adjacent (or closely spaced) data points using latitude, longitude and time and, optionally, altitude for additional precision. Other measures may be suitable as well.

The foregoing location data may be stored temporarily or permanently on the local storage 106 of the location tracking module 100. The collected location data is further relayed to a location database 110, where it is stored and indexed to an identifier for the particular airtanker (i.e., an Airanker ID). The location data may be transmitted wirelessly in real time or near real time to the location database 110 via a wireless gateway 112, or could be loaded (synced) with the location database 110 upon return of the airtanker by a wired link 114 or the wireless link via wireless gateway 112. Advantageously, if a wireless implementation during travel is provided, it will be appreciated that an additional function of real time centralized tracking of the airtanker may be provided.

A forest fire database 116 is further provided. The forest fire database 116 is provided with forest fire data that may be inputted by a dispatch or operations administrator (hereinafter, the “dispatcher”), and may be augmented by automatically populated data gathered from third party sources 118 (an example of which is fire weather index provided by an environmental data source 120 or geographic topology from a geographic data source 122), any of which could be provided to the system via a link to a network 124, such as via the internet. The dispatcher typically receives a report of a forest fire in the jurisdiction served by the airtankers. Upon receiving such report, the dispatcher enters the forest fire data. Forest fire data comprises the approximate location of a forest fire, date of the forest fire attack and the number of airtankers dispatched to the forest fire. Forest fire data may further comprise fire start date, fire discovery date, first report date, second report date, getaway date, attack date, being held date, under control date, out date, fuel type, estimated spread rate, estimated size at initial attack, estimated size at report time, the locations of the airtankers at takeoff and/or landing or any other data that may be available to forest fire attack operations personnel in respect of specific forest fires.

The dispatcher, along with other decision makers, determines whether to dispatch one or more airtankers to the fire. Typically, in addition, airtankers are dispersed geographically across the jurisdiction and the dispatcher selects the appropriate airtankers to dispatch based on a combination of proximity to the fire and availability of airtankers at that time. The number and locations of the airtankers may also be entered into the forest fire database.

Upon the collection of location data and forest fire data corresponding to a plurality of forest fires (and preferably, given a large amount of such data), the processing module 126 obtains the location data and forest fire data to generate the operations data, which can be used to understand what is happening with each airtanker at relevant times. This includes which fire was being fought, whether the airtanker was circling and waiting near the fire, which portions of the travel path were associated with travel to and from the fire, which portions of it were associated with repeatedly flying between the fire and the lake from which the airtanker scoops water to drop on the fire or when, and where or how many drops were made on each fire.

An airport database 128 may further be provided. The airport database comprises location information for all airports in the jurisdiction served by the airtankers. Each airtanker will take off and land at an airport, though the airport of takeoff may differ from the airport of landing for any given trip.

An airtanker database 130 may further be provided. The airtanker database comprises specifications of the various airtanker models available in the airtanker fleet and for which location data is being collected. An example of an airtanker used in Ontario, for example, is the Bombardier™ CL-415. The CL-415 is an amphibious waterbomber, meaning it can land on an airport runway or bodies of water. It also has the capability to fly just above the surface of a lake or river and scoop up water simultaneously.

The stored specifications comprise cruising and service speed and altitude levels as well as constraints related to geographic constraints for the particular airtanker. According to Bombardier, for example, the CL-415 has a normal cruising speed of 180 kt (333 km/hr) and a stall speed of 68 kt (126 km/hr). Water scooping can be achieved for a body of water at least 1,340 metres long, 90 metres wide and 2 metres deep. The airtanker requires about 410 metres on the water to make a pick up, but the remainder is needed for its approach and climb-out. The CL-415 typically travels at 70 kt (130 km/hr) along the body of water to scoop up a 6,137-litre water load. Therefore, the scooping time is approximately 11-12 seconds. Once the airtanker arrives at the fire with a full load, it is typically travelling at 110 kt (204 km/hr) and will drop its load 30 to 35 metres above the treetop level. Each of the foregoing specifications are stored in the airtanker database 130 and may be applied as validation constraints by the processing module 126. Alternatively, the airtanker database may be omitted, for example where only one type of airtanker is present in a fleet and the processing module can be configured directly in accordance with specifications of that airtanker.

The airtanker database further comprises, for each airtanker, an indicator of whether the airtanker is capable of in-flight water pickup. If it is not, the airtanker database may comprise an indicator of the fire retardant capacity of the airtanker.

In the system provided herein, the processing module is operable to more accurately model the service process using collected historical data. The processing module is operable to determine the beginning and ending points of the various segments in the service cycle by applying the pattern recognition process to the collected forest fire data and location data with reference to the airport database and specification constraints of the airtanker database.

The processing module is linked to the airport database and airtanker database and cross references airtanker specifications with forest fire data, airport data and collected airtanker location data to generate trip segments. The processing module applies a pattern generation process that enables it to make determinations regarding which data points of the collected location data correspond to the segments of the service cycle and to apply a parsing process to determine what is occurring within the segments. These rules correspond with the typical process associated with forest fire initial attack as well as the application of the airtanker specifications. Measures and events determined by the processing module are stored in an ASP database 132.

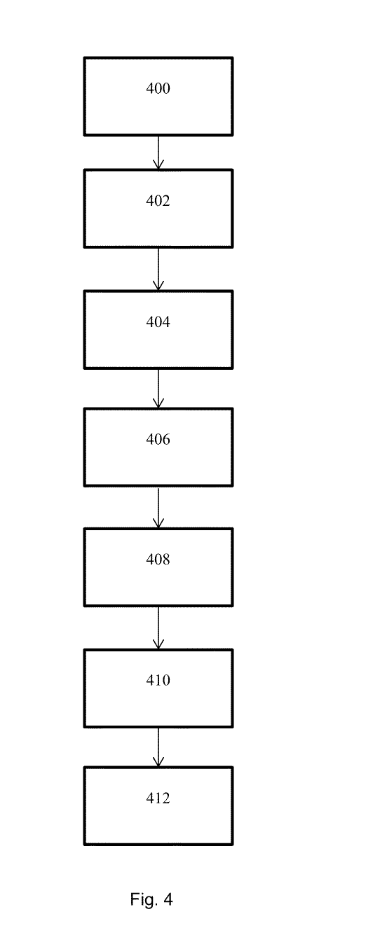

Referring now to FIG. 4, at block 400, the processing module first partitions the location data into a series of airtanker trips. Each trip is defined by a series of data points that represent the airtanker travelling from an airport to perform some task (e.g., fight one or more fires) and returning to an airport. Between trips, airtankers may be refuelled, they may be simply sitting there while the pilot waits to receive further instructions, they may be receiving maintenance at the airport or, possibly, being reloaded with fire retardant. In one implementation, the location tracking module less frequently obtains location data when the airtanker is powered down. Consequently, in this implementation, the processing module generates a new trip when there is a long interval (e.g., at least 10 minutes) between location data points. An exemplary interval should be sufficiently longer than the time between a plurality of data points during travel since gaps in the data (during travel) can occur if the location signal (GPS signal) is temporarily blocked by atmospheric disturbances. The selected interval should further be at least slightly less than the interval between location data points when the airtanker is at rest (which was specified as 20 minutes in the example previously provided). Alternatively, and particularly if the location tracking module does not reduce the frequency of obtaining location data during power down, the new trip can be generated when a long interval is determined between location data points that indicate different locations, which may be more useful where the location module gathers location data at a set frequency regardless of whether the airtanker is at rest or in transit.

At block 402, the processing module filters out any non-airtanker fires from the forest fire database. This can be determined by discarding any forest fire record that indicates no airtankers were dispatched. At block 404, the processing module performs a matching process, which identifies a set of possible trips that might be matched to each fire. A fire may be assigned to a trip if it falls within a preconfigured range of the airtanker for at least one point in time during the airtanker trip. Each point that falls within the preconfigured range is referred to as a fire event. An exemplary range may, for example, be 5 km.

At block 406, the processing module filters out any matches that correspond to a fire not active during the time of the trip. Active fires are those for which the airtanker's trip date is within the time marked as the beginning and extinguishing of the fire as stored in the forest fire database.

It will be appreciated that the foregoing steps may be executed in a different order.

Following execution of block 406, a set of matches are provided for airtankers within the preconfigured range of an active fire. However, it will be appreciated that it is possible that an airtanker will fly past an active fire while it is heading to its assigned active fire. In this case, when there are fire events from different fires on the same trip, at block 408, the processing module executes a conflict resolution process to determine which active fire more likely corresponds to the trip. The conflict resolution process may, for example, match the airtanker trip to the fire where the most of its fire events occurred, which can be determined by analyzing the collective proximity of its location to each of the fires.

At block 410, the processing module generates the start and end locations for each trip. Each trip starts and ends with the airtanker at an airport. Each trip may be allocated to airports based on proximity within a preconfigured tolerance of its first and last location data points to airports in the airport database. The tolerance may, for example, be approximately 5 km, accounting for any uncertainty in the relative location of the runway to the recorded location of the airport and the possibility of an airtanker's location not being immediately picked up by the location tracking module when it is first powered on and set in motion down the runway. A start (power up) time and end (power down) time, corresponding to the data points of start and end location, respectively, are also determined. For airtankers that are not capable of in-flight water pickup, a retardant pickup event may also be generated and correspond to the time and location between the end time and location for a trip and the start time and location for the subsequent trip.

At block 412, the processing module generates water pickup data in cases where the airtanker for which the trip data relates is one that is capable of in-flight water pickup. Generating water pickup data comprises establishing the water pickup and water drop times and locations for attacking a fire. Each airtanker cycles between the fire and the lake from which it picks up water to be dropped on the fire. A measure of “drop time” may be used to represent the time between consecutive drops of water on the fire. A drop time versus lake-to-fire distance model may further be generated. Determining when subsequent loads of water are dropped on the fire would provide an approximation of drop times, but not any information about the distance to a usable lake. To account for this, the processing module can generate the time and location data corresponding to the airtanker skimming water from the surface of a lake, which may be defined as a “water pickup event”.

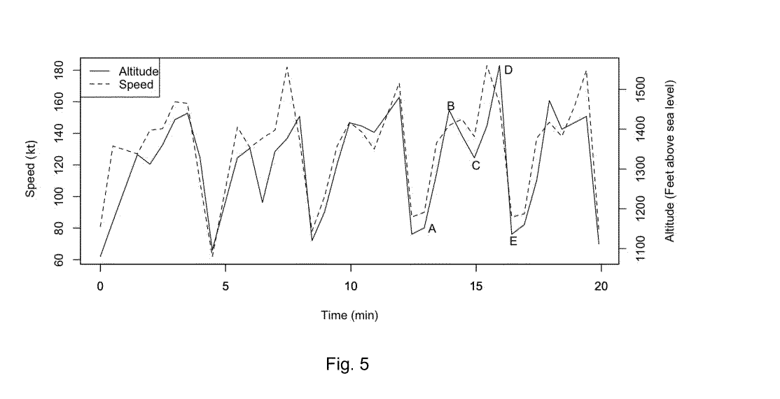

Identification of the water pickup event may be based on two characteristics of airtanker behavior observed by the applicants and shown in FIG. 5: 1) the airtanker speed decreases sharply to ensure a safe pickup of water, and 2) the airtanker flies at a lower altitude in order to scoop water from a lake. Notably, water pickup is generally cyclical with the pattern repeating itself every 3-4 minutes in the example shown in FIG. 5. It has been found that each cycle can be partitioned into 4 basic events per cycle (labeled in FIG. 5 as points A through E). Points A and E correspond to altitude minimums for each cycle, which the processing module allocates to the airtanker making a water pickup (in the example shown these altitudes are between 1100 and 1150 feet, however it will be appreciated that the altitudes will depend on the general altitude above sea level of the particular area being serviced, which is determinable with reference to the geography database). The location at these points is deemed to be the lake location. From point A to point B, altitude and speed have increased significantly, and the processing module allocates this segment to the airtanker travelling from the lake to the fire. From point B to C, the airtanker is slowing down and decreasing altitude, though not to a minimum (as A or E), which the processing module allocates to water drop. The location at the corresponding time is deemed to be the fire location. From C to D, the airtanker increases speed and altitude, which the processing module allocates to the airtanker heading back towards the water source. Finally from D to E, the airtanker dives down for another water pickup. In general, there is a slight decrease in altitude and speed when an airtanker is approaching a fire, generally to ensure an accurate drop. The changes in altitude and speed, however, are not nearly as drastic and repeatable when compared to those associated with water pickups. For this reason, identification of points A and E are executed first, while identification of points B, C and D follow.

The processing module may determine the water pickup locations (lake locations) from local minimum altitudes, which may further be determined using a moving window approach of location data, including both altitude and speed. Depending on the frequency of the location data, a particular number of consecutive altitude recordings can be considered. In an example, where location data is collected every 30 seconds, a set of 5 data points may be considered so that each consideration includes a 2 minute period. It has been found that a 2 minute period typically provides suitable time to capture the airtanker's behaviour during the pickup portion of the drop cycle. The processing module, in this case, determines if the current altitude, a_{c} is the minimum of the set (a_{c-2}, a_{c-1}, a_{c}, a_{c+1}, a_{c+2}) corresponding to data points recorded at times t_{c-2}<t_{c-1}<t_{c}<t_{c+1}<t_{c+2}, respectively. A greater or lesser number of data points may be included in the consideration.

Analyzing altitude alone may not be sufficient to identify a pickup event. Altitude patterns are also present during other phases of the airtanker's trip, such as at takeoff, landing, and in-transit to and from the fire. However, it has been found that during water pickup, airtanker speed exhibits a minimum and maximum. The processing module may establish threshold minimum and maximum pickup speeds with reference to specifications of the airtanker available in the airtanker database. In other words, the thresholds should remain within a range of the operational speeds for the various segments of a water pickup event.

Additionally, the processing module verifies that speed may not decrease past the minimum threshold speed within a preconfigured time of the possible pickup event, since during takeoff/landing, airtanker speed may increase from/decrease to rest, so preceding/following speed recordings will violate this restriction and not be identified as pickup events. This period may, for example, be a 2 minute period, which for 30 second data intervals can be represented as s_{c-2}, s_{c-1}, s_{c}, s_{c+1}, s_{c+2}>minimum speed.

In an example, for CL-415, the airtanker database is loaded with data indicating that speeds are typically between 110 kt (204 km/hr) and 30 kt (56 km/hr) for a water pickup event. The upper bound on airtanker speed, s_{c}, removes false positive pickup events during the transit portion of an airtanker's trip while the lower bound on s_{c} (≧30 kt) removes false positive pickup events during takeoff and landing. Further, a requirement that speed not decrease over a period of 2 minutes from the proposed pickup event below the lower bound (e.g., 30 kt) is applied. This prevents a speed of over the lower bound from being identified as a water pickup event when a subsequent speed is lower than the lower bound, which in fact likely indicates a landing.

At block 414, the processing module populates the ASP database, including with the operations data generated for airtanker trips in blocks 410 and 412, along with various other data obtainable or derivable from the forest fire database and airport database.

The ASP database provides a plurality of data items, which includes:

(a) Events, including:

(i) Takeoff: when the airtanker takes off from a particular airport (obtained at block 410);

(ii) On-scene arrival: when the airtanker arrives on-scene of a particular fire (corresponding to the time of the first water pickup event, obtained at block 412);

(iii) Water pickup: when and where the airtanker scoops water from a particular lake, which is obtained at block 412 wherein for each water pickup the time and location of the corresponding location data point is collected;

(iv) On-scene departure: when the airtanker departs from the scene of a particular fire, which corresponds to the time of the last fire event (obtained at block 404), which may be assumed to be last of the plurality of fire events that occur during the drop process since within the preconfigured range; and

(v) Landing: when the airtanker arrives back at a particular airport (obtained at block 410); and

(b) Measures, including:

(i) Pre-travel delay: time between when a fire is reported (as recorded in the forest fire database) and when an airtanker takes off from an airport (obtained by a calculation of the takeoff time from at block 410 and the time the fire was reported as stored in the forest fire database);

(ii) Base-to-fire distance: straight-line distance between the origin airport (recorded in the airport database) and a particular fire (location recorded in the forest fire database) attacked by an airtanker during its trip. The fire's recorded location is an approximation since a fire's perimeter can extend over a large geographic area. In order to generate the distance between the two points, the subtended angle may be determined using the Haversine formula, accounting for the spherical surface of Earth, given by:

$$Δ σ = 2 arcsin ( \sqrt{{sin}^{2} ( \frac{{φ}_{s} - {φ}_{f}}{2} ) + cos {φ}_{s} cos {φ}_{f} {sin}^{2} ( \frac{{λ}_{s} - {λ}_{f}}{2} )} )$$

where φₛ, λₛ, φ_{f}, λ_{f} are the geographical latitude and longitude of the two points. The arc length formula, d=rΔ\hat{σ}, where r=6378 km is the average radius of the Earth, may be applied to convert the subtended angle to a distance;

(iii) Base-to-fire travel time: time between when an airtanker takes off from the origin airport and when it arrives on-scene of a particular fire, both of which are given above;

(iv) Response time: time between when a fire is reported (recorded in the forest fire database) and when the first airtanker arrives on-scene of a particular fire;

(v) On-scene time: time between when the first airtanker arrives on-scene of the fire and the on-scene departure of the last airtanker leaving the scene of the fire;

(vi) Lake-to-fire distance: straight-line distance between the landable lake and the fire. This distance is also calculated using Haversine's formula and can be approximated by taking the average straight-line distance between each water pickup event location (obtained at block 412) and the fire (location recorded in the forest fire database);

(vii) Drop time: time between each successive water pickup event (obtained at block 412);

(viii) Fire-to-fire distance: straight-line distance between successive fires (locations recorded in the forest fire database) visited by an airtanker during the same trip;

(ix) Fire-to-fire travel time: time between when an airtanker leaves the scene of one fire (obtained at block 404) and arrives on the scene of another fire during the same trip (assumed to be the time of the airtanker's first water pickup event at that fire, obtained at block 412);

(x) Fire-to-base distance: straight-line distance between a particular fire (location recorded in the forest fire database) and the destination airport (location recorded in the airport database);

(xi) Fire-to-base travel time: time between when an airtanker leaves the scene of the fire (obtained at block 404) and arrives at its destination airport (obtained at block 410);

(xii) Trip time: time between when an airtanker takes off from the origin airport (obtained at block 410) and arrives back at its destination airport (obtained at block 410);

(xiii) Service time of a fire: time between when the first airtanker leaves its origin airport (obtained at block 410) and last airtanker arrives back at its destination airport (obtained at block 410). When only one airtanker is dispatched to a fire, the service time may be generated as S=A−D, where A is the arrival time of an airtanker back at its base, and D is the departure time (i.e., when it originally left its base). Further determinations are required when multiple airtankers are dispatched as a part of the initial attack team; for M airtankers dispatched to a fire, there are M entries of departure time and M entries for time of arrival back to base. Let Dᵢ, i=1, 2, . . . , M be the departure time of the ith airtanker to depart and Aⱼ, j=1, 2, . . . , M be the arrival time of the jth airtanker back at an airport. Then the service time is generated as S=A_{M}−D₁. For M=1, this reduces to S=A₁−D₁.

$$S := \{ \begin{matrix}{S}_{E , M} - {S}_{B , 1} \\ {T}_{BF , 1} + {T}_{OS} + {T}_{FB , M} \\ {T}_{BF , 1} + ( {N}_{drops} \times {T}_{drop} ) + {T}_{FB , M}\end{matrix}$$

where T_{OS}=OS_{D,M}−OS_{A,1} is the on-scene time (the time between when the first airtanker arrives on scene (OS_{A,1}) and the last airtanker departs the scene of the fire (OS_{D,M})), which can also be expressed as the number of drops on a fire, N_{drops}, multiplied by the average drop time, T_{drop}−S_{E,M} is the time when the last airtanker is powered down, S_{B,1} is the time when the first airtanker is powered up, T_{BF,1} is the base-to-fire travel time of the first airtanker to power up and T_{FB,M} is the fire-to-base travel time of the last airtanker to power down.

(xiv) Number of drops per trip: number of water drops (obtained at block 412) made by one airtanker during one trip;

(xv) Number of drops per fire: number of water drops (obtained at block 412) made by one or more airtankers on a particular fire;

(xvi) Number of airtankers per fire: number of airtankers dispatched to a particular fire (obtained following the execution of block 408);

(xvii) Airtanker availability: whether an airtanker is available to be dispatched at a particular time (obtained by checking if the particular time falls within an ordered set of power up and power down times (obtained at block 410));

(xviii) Number of airtankers dispatched from an airport (obtained at block 410);

and (xix) Number of airtankers that land at an airport (obtained at block 410).

Additionally, the ASP database may comprise the following additional items;

(xx) AirtankerID: unique airtanker ID (obtained from the location tracking module);

(xxi) Airtanker type: the type of airtanker (e.g., CL-415) (obtained from the airtanker database); and

(xxii) Fire information: location, year, district, number, environmental information, size at initial attack, fuel type, obtained from the forest fire database.

It is contemplated that third parties may develop and provide tools leveraging the operations data available via the ASP database. Some examples are now described.

Descriptive analytics tools may utilize the operations data provided, comprising applications that apply one or more statistical methods to the ASP database, including descriptive statistics and graphical data representations (e.g., time series, histograms, pie charts, scatter plots). Fire managers could use such tools to analyze historical performance of individual airtanker models (e.g., travel times) and the initial attack airtanker system (e.g., service times or response times).

Predictive analytics tools may also utilize the operations data and comprise applications that apply one or more statistical methods to the ASP database for building predictive models, including but not limited to: (a) airtanker travel time models for various segments of the trip, including travel to the fire, drop process activities and travel back to base (using, for example, linear regression with distance as a predictor); (b) airtanker dispatch probability models for predicting the likelihood that an airtanker will be dispatched to a fire (using, for example, logistic regression with reported fire size, spread rate, fuel type, fire weather indices, and number of available airtankers as predictors); (c) number of drops model for predicting the number of drops to contain a particular fire (using, for example, zero-truncated Poisson regression with fire size at initial attack, spread rate, fuel type and fire weather indices as predictors); and (d) containment probability model for predicting the likelihood that a fire will be contained if one or more airtankers are dispatched to a newly reported fire within a range of times (using, for example, logistic regression with number of dispatched airtankers, time interval, reported fire size, spread rate, fuel type and fire weather indices as predictors).

Prescriptive analytics tools may also utilize the operations data and comprise applications that apply operations research methods (e.g., simulation, queueing theory, mathematical programming/optimization) for enabling fire managers to resolve complex decision-making problems.

Dispatch tools may also utilize the operations data and comprise applications used by forest fire management agency staff for dispatching airtankers. Dispatchers can benefit from having real time ASP data that includes, for example, the position of airtankers, their status (e.g., available to be dispatched/servicing a fire) and how many drops are being made.

Real time information systems may also utilize the operations data and comprise applications to be utilized by fire managers and agency staff. These applications may, for example, comprise mobile device or desktop graphical applications for displaying real time ASP data.

Third party models may leverage the populated ASP database to enable dispatchers to make better dispatch decisions. It is commonly appreciated that there is a relationship between the service time of forest fires and other factors such as: the availability of airtankers at the time of dispatch; the number of airtankers used for suppressing a fire; fire, lake and airport locations; current and forecast weather conditions; characteristics of the fire; and the deployment, redeployment, and dispatching strategies. The ASP database enables a data-driven empirical analysis of these relationships. The location of the fire, the lake from which water is being picked up, and the airport from which an airtanker is dispatched are important pieces of information that, when known with reasonable certainty, allow upper and lower bounds to be put on the service time. In another example usage of the ASP database, decision support tools may be provided for use by fire managers to simulate how the initial attack airtanker system will perform under many possible fire occurrence scenarios (e.g., where, how many, and how often fires could occur), assisting in the planning of dispatch. When fire managers develop their deployment strategies for the next day, the location of tomorrow's fires and their respective pickup lake are not known. Fire managers must decide where and how many airtankers to deploy at the beginning of each day and how to redeploy them over the course of the day in order to minimize airtanker response time to fires. Fire managers attempt to minimize travel times to fires by deploying airtankers close to areas where fires are expected to occur.

A third party may further provide diagnostic models that provide summaries of the forest fire attacks of a particular jurisdiction. These summaries may provide more basic metrics of which airtankers are most used, which airports are most used for takeoff/landing and areas within a jurisdiction that experience greater numbers of forest fires. More advanced metrics may include which airtankers are generally better for deployment to a particular area, perhaps based upon fuel capacity in connection with distance from base to fire; or which airports are most capable of redeploying a recently landed airtanker, for example.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A system for generating forest fire attack operations data, the system comprising:
a. a location database configured to store location data corresponding to each of a plurality of airtankers used for forest fire air attack;
b. a forest fire database for storing forest fire data;
c. a processing module operable to generate, using said location data and forest fire data, said operations data comprising a plurality of trip segments for each airtanker for each forest fire air attack and events and measures corresponding to said trip segments.

2. The system of claim 1, wherein said trip segments comprise a start location, and end location and one or more water pickup events.

3. The system of claim 2, wherein said processing module applies a pattern recognition process to determine the time and location of each of said one or more water pickup events.

4. The system of claim 3, wherein said events comprise water dropoff events.

5. The system of claim 2, wherein said one or more water pickup events are identified by said processing module locating local minimums of altitude satisfying a maximum and minimum threshold constraint.

6. The system of claim 2, wherein said one or more water pickup events are identified by said processing module locating local minimums of speed satisfying a maximum and minimum threshold constraint.

7. The system of claim 1, wherein said processing module is operable to determine a service time for said forest fire using said operations data.

8. The system of claim 1, wherein said processing module enables the provision of decision support tools using said operations data.

9. The system of claim 2, wherein said processing module determines said start location and said end location for one of said airtankers for one of said fires by an analysis of adjacent location data points for said airtanker.

10. The system of claim 9, wherein said analysis comprises locating adjacent location data points that are separated by a sufficiently long time interval.

11. A method for generating forest fire attack operations data, the method comprising:
a. obtaining location corresponding to each of a plurality of airtankers used for forest fire air attack;
b. obtaining forest fire data;
c. generating, by a processor, using said location data and forest fire data, said operations data comprising a plurality of trip segments for each airtanker for each forest fire air attack and events and measures corresponding to said trip segments.

12. The method of claim 11, wherein said trip segments comprise a start location, and end location and one or more water pickup events.

13. The method of claim 12, wherein said generating comprises applying pattern recognition to determine the time and location of each of said one or more water pickup events.

14. The method of claim 13, wherein said generating further comprises determining water dropoff events.

15. The method of claim 12, wherein said one or more water pickup events are identified by said processing module locating local minimums of altitude satisfying a maximum and minimum threshold constraint.

16. The method of claim 12, wherein said one or more water pickup events are identified by said processing module locating local minimums of speed satisfying a maximum and minimum threshold constraint.

17. The method of claim 11, wherein said measures comprise a service time for said forest fire using said operations data.

18. The method of claim 11, wherein said operations data enables the provision of decision support tools.

19. The method of claim 12, wherein said start location and said end location for one of said airtankers are determined for one of said fires by an analysis of adjacent location data points for said airtanker.

20. The method of claim 19, wherein said analysis comprises locating adjacent location data points that are separated by a sufficiently long time interval.
